(19) United States
(12) Patent Application Publication
(10) Pub. No.: US 2016/0297662 A1
(43) Pub. Date: Oct. 13, 2016

(54) DEVICE FOR VARYING THE VOLUME FLOW OF A FILL PRODUCT IN A FILLING PLANT

(71) Applicant: KRONES AG, Neutraubling (DE)

(72) Inventor: Sebastian Baumgartner, Prackenbach (DE)

(21) Appl. No.: 15/094,700

(22) Filed: Apr. 8, 2016

(30) Foreign Application Priority Data
Apr. 9, 2015 (DE) 10 2015 105 352.7

(51) Int. Cl. B67C 3/28; F16K 1/14; F16K 31/08

(52) U.S. Cl. CPC B67C 3/286; F16K 31/08; F16K 1/14

(57) ABSTRACT

A device for varying the flow rate of a fill product in a filling plant is provided. The device includes a control chamber connected with an intake and an outlet, and a control element accommodated in the control chamber, which is displaceable within the control chamber by interaction with a drive disposed outside the control chamber. The cross section of the control chamber varies steplessly between an end of the control chamber facing the intake and an end of the control chamber facing the outlet.

### CROSS REFERENCE TO RELATED APPLICATION

This application claims priority from German Patent Application No. DE 10 2015 105 352.7, filed on Apr. 9, 2015 in the German Patent and Trademark Office, the disclosure of which is incorporated herein by reference in its entirety.

### BACKGROUND

1. Technical Field

The present invention relates to a device for varying the volume flow of a fill product in a filling plant, in particular in a beverage filling plant.

2. State of the Art

In the field of beverage filling plants, it is known to introduce fill product into containers that are to be filled in such a manner that during the actual filling process the volume flow of the fill product can be switched back and forth between two different volume flow rates. In this it is, for example, advantageous first to fill at a reduced volume flow rate at the beginning of the filling process, then to fill at a high volume flow rate during the main part of the filling process, and then towards the end of the filling process again to fill at a reduced volume flow rate. The use of a reduced volume flow rate at the beginning of the filling process ensures that the fill product in the container that is to be filled does not foam excessively. This is because the height that the fill product falls into the still unfilled container, and hence the tendency to foam, is at its greatest at the beginning of the filling process. During the main part of the filling process, it is possible to accelerate the filling by filling at a higher volume flow rate. Towards the end of the filling process, the volume flow rate is again reduced, in order to facilitate a defined cut-off of the fill product flow when a predetermined cut-off criterion is fulfilled, for example when a predetermined fill volume, a predetermined fill height or a predetermined fill weight is reached. In addition, towards the end of the filling process, a neck area of the container that is to be filled, for example a bottle to be filled, is usually reached. In this area, the container to be filled has a reduced cross section, and therefore the level of fill product in the container would rise very rapidly towards the end of the filling process if the volume flow rate remained the same. By reducing the volume flow rate towards the end of the filling process, it is therefore possible to adjust the speed at which the fill product level rises in the neck area of the almost fully filled container, making it possible to reach the end of the filling process reliably and without overshoot of the fill product.

In order to switch back and forth between two different volume flow rates in a filling element of a filling plant, it is known to vary the position of the filler valve, wherein the filler valve at the same time also performs a closing function in order to end and start the flow of fill product.

It is further known to switch back and forth between two different volume flow rates by means of product flow restrictors. The product flow restrictors are usually provided in the form of a bellows, which reduces or expands the flow cross section in a path along which the product is conveyed.

Proportional regulation of the volume flow is also known, for example from DE 10 2012 211 926 A1, in which adjustment of the volume flow rate is made possible by means of a control valve. A hygienic design of this control valve is achieved by means of an arrangement of corrugated bellows.

### SUMMARY

An improved device for varying the volume flow of a fill product in a filling plant is described.

Accordingly, a device for varying the flow rate of a fill product in a filling plant is provided in one embodiment, comprising a control chamber connected with an intake and an outlet, and a control element accommodated in the control chamber, which is displaceable within the control chamber by interaction with a drive disposed outside the control chamber. The cross section of the control chamber varies steplessly between an end of the control chamber facing the intake and an end of the control chamber facing the outlet.

Due to the fact that the cross section of the control chamber varies steplessly between an end facing the fill product intake and an end facing the fill product outlet, it is accordingly possible to provide a device for varying the flow rate that enables stepless adjustment of the flow rate. By this means, the progress of the filling process in a filling plant can be advantageously adapted to the characteristics of the respective fill products and to the geometries of the respective containers. Because it is possible to vary the flow rate steplessly during the filling process, a further improvement in the filling outcome can be achieved. At the same time, by means of the control element that is accommodated in the control chamber, it is possible to achieve a particularly hygienic design, which dispenses with the use of bellows for sealing.

In order to enable particularly simple control of the control element, and accordingly enable stepless, proportional adjustment of the effective flow cross section, the cross section of the control chamber is in certain embodiments configured such that it changes according to a predetermined mathematical function between the end facing the intake and the end facing the outlet. Then by appropriate control of the control element, it is possible to obtain a change in the flow cross section, and hence in the flow rate, that can be easily calculated by means of the predetermined mathematical function. Thus, the control of the drive, e.g., of the control element, is particularly simple, and the flow can be adjusted to the desired rate for each filling situation.

The control chamber can be a control chamber with a circular cross section whose radius, for example, changes linearly from the end facing the intake to the end facing the outlet. I n this case, the effective flow cross section can be calculated in a simple manner by calculating the circular area of the control chamber (A=π*r²) and subtracting the effective cross section of the control element. This effective flow cross section can thereby be calculated for any position of the control element between the end of the control chamber facing the intake and the end of the control chamber facing the outlet. The effective flow cross section can thereby be adjusted directly by the appropriate positioning of the control element within the control chamber.

Stepless adjustment of the possible flow rates also results if the cross section of the control chamber changes continuously between the end facing the intake and the end facing the outlet.

In a particular variant, the control chamber is substantially conical in shape, which enables both simple manufacture of the control chamber—for example by means of conical milling cutters—and the establishment of a simple mathematical relationship between the position of the control element in the control chamber and the resultant effective flow cross section in each case. The control of the device is thereby made easier, and adjustments can be made in a simple manner to achieve optimum filling conditions for each container and each container fill level.

The control element can, in several embodiments, be displaced back and forth in the control chamber between a position with a small cross section and a position with a large cross section, and in one embodiment, linearly displaced back and forth so that stepless adjustment of the resulting effective flow cross section between the two extreme positions is provided.

The drive is, in some embodiments, configured such that it can move the control element back and forth only between the position with the smallest possible cross section and the position with the largest possible cross section, but not beyond this range. In particular, it is not possible for the drive and the control element to close the device and thereby stop the flow completely. The device thus does not function as a valve with a valve seat by means of which the applicable flow path can be closed completely. Instead, the device supplies a minimum flow at all times when the control element is in the position with the small cross section. Accordingly, no valve seat is provided. The control element can thus not be accommodated in a valve seat such that it forms a seal.

In order to ensure that the control element cannot close the control chamber, the drive, in various embodiments, has a stop to confine the movement of the drive, and hence of the control element, to the region between the first end position and the second end position, wherein the stop is, in one particular embodiment, implemented mechanically.

The control element, in certain embodiments, has a spherical shape, and in one particular embodiment, is in the form of a ball. By this means, a good hygienic design can be provided, since the surfaces can be cleaned easily.

Furthermore, the control element is, in some embodiments, accommodated in its entirety within the control chamber. The entire control element is thus also in the product flow, so that from all sides it is substantially immersed in, or at least wetted by, the flow of the applicable fill product. Complete immersion in the flow, or complete wetting by it, also exists if the control element is in point or line contact with the interior wall of the control chamber and the fill product is substantially displaced in the position at which point or line contact is made.

The control element is, in several embodiments, substantially unguided within the control chamber, so that if for any reason the drive that is disposed outside the control chamber ceased to operate, the control element would be free to move in an unguided manner inside the control chamber, and could in principle adopt any position.

Because the control element is, in some embodiments, accommodated in its entirety within the control chamber, and moves back and forth within the control chamber between the position with a small effective flow cross section and the position with a large effective flow cross section, wherein it is fully surrounded by, immersed in or wetted by the fill product, no pressure peaks arise during processes of switching from a first effective flow cross section to a second effective flow cross section, such as occurs for example in designs known from the state of the art in which a control chamber has a stepped cross section, or a design in which a control valve engages with a valve seat. Accordingly, variation of the flow rate of the fill product can be carried out both proportionally and steplessly, as well as without pressure peaks, with the result that the flow of fill product can be regulated very gently even during the filling process. By this means, the filling outcome can be further improved.

The connection between the control element and the drive is, in one particular embodiment, implemented magnetically. Accordingly, the control element is, for example, formed from a magnetizable or magnetic material, for example from a magnetic rustproof steel or stainless steel, and the drive acts upon the control element via suitable magnets or counter-magnets disposed outside the control chamber, by means of which the control element accommodated in the control chamber can be displaced by the drive.

In connection with this it should be noted that, due to the entire control element being accommodated in the control chamber, such that it is at all times fully surrounded by fill product, the forces that are needed to displace the control element, which must be transmitted from the drive to the control element, do not depend on the pressure of the fill product. In particular, carbonated fill products at a high pressure can also be filled in this manner in a beverage filling plant without problems. By this means, the device can vary the flow rate of the carbonated fill product, since the control element, which is accommodated in its entirety within the control chamber, is subjected from all sides to the same pressure from the fill product. Thus the forces exerted by the pressurized product upon the control element cancel each other out, with the result that the control element can be displaced by a moderately sized drive independently of the pressure of the particular fill product.

The walls of the control chamber and the surface of the control element are particularly easy to clean, since it is possible in this case to dispense with the use of for example bellows, and the respective surfaces can be designed to be completely smooth and continuous surfaces, without indentations or structures that could be difficult to access for cleaning.

The drive and the control element, in various embodiments, interact with each other in a contact-free manner. By this means, the hygiene situation can be still further improved.

Thus, the proposed device for varying the flow rate provides a system that can be economically manufactured, which contains few parts that are subject to wear, and which enables a good hygienic design.

The coupling between the drive and the control element can be configured such as to enable reliable displacement of the control element within the control chamber. The coupling between the drive and the control element, which is for example by means of a suitable magnetic interaction, does not however need to be designed to be excessively strong. This is because the control element is always in the fill product that is to be regulated, and thus the pressure conditions acting upon the control element are substantially the same from all sides. This design differs from the designs known from the state of the art, in which the control element is also used as a shut-off valve, with the result that, when the control element is accommodated in the valve seat and thereby provides a complete seal, the pressure on the side of the control element that faces the fill product intake is substantially higher than the pressure on the side of the control element that faces the fill product outlet. In the latter case, the coupling between the control element and the drive must transmit forces large enough to enable the control element to be subsequently raised out of the valve seat against the prevailing pressure conditions. This can be dispensed with in the proposed device for varying the flow rate as described above, since the control element is not provided in order to close the device.

In addition, means are, in some embodiments, provided for preventing complete closure of the control chamber by the control element in the control chamber, for example bars, ribs, deflectors, deflecting brackets, spacers and/or stops disposed in the area of the outlet. In this manner, it is possible to prevent the control element from completely closing the fill product outlet or fill product intake. Instead, it is envisaged that the control chamber and the control element are configured such as to achieve a predetermined minimum flow rate at all times, and the entire control element is surrounded or wetted by the fill product at all times.

### BRIEF DESCRIPTION OF THE FIGURES

Further embodiments and aspects of the present invention are more fully explained by the description below of the figures.

FIG. 1 shows a schematic sectional view through a device for varying the flow rate of a fill product in a filling plant in a first switched state according to an example embodiment of the present invention; and

FIG. 2 shows the device from FIG. 1 in a second switched state.

### DETAILED DESCRIPTION

Examples of embodiments are described below with the aid of the figures. In the figures, elements which are identical or similar, or have identical effects, are designated with identical reference signs. In order to avoid redundancy, repeated description of these elements is in part dispensed with.

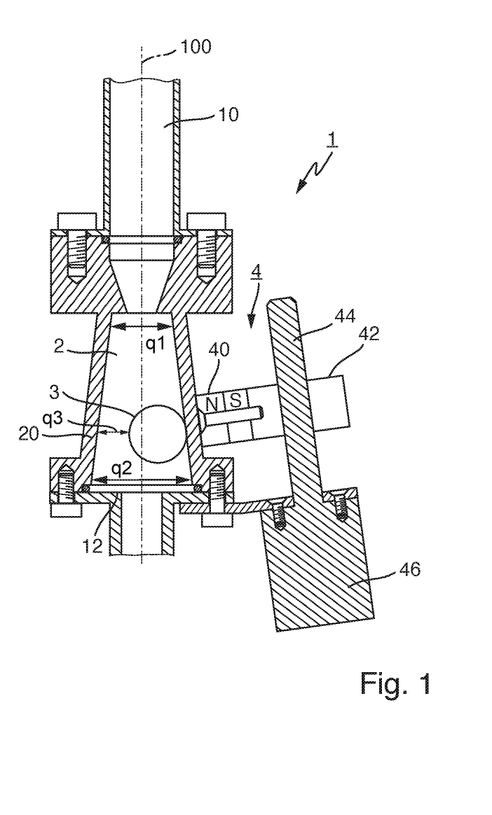

FIG. 1 shows a device 1 for varying the volume flow of a fill product in a filling plant. The device 1 is for example disposed between a fill product vessel (not shown here), which is connected via an intake 10 with the device 1, and an outlet 12, through which the fill product flows out of the device 1 and is conveyed into a container that is to be filled, for example via a dispensing aperture or a control valve to control the flow of fill product.

The device 1 includes a control chamber 2, which is disposed between the intake 10 and the outlet 12. Fill product is supplied via the intake 10 and flows through the control chamber 2. The fill product then leaves the control chamber 2 via the outlet 12.

The control chamber 2 accommodates or houses a control element 3, which interacts with a drive 4 disposed outside the control chamber 2. By means of the drive 4 disposed outside the control chamber 2, the control element 3 can be positioned, and in particular also displaced, within the control chamber 2.

The cross section of the control chamber 2 varies steplessly between an end of the control chamber 2 facing the intake 10 and an end of the control chamber 2 facing the outlet 12. In the example embodiment that is shown, the control chamber 2 has a first cross section q1 at its end which faces the intake 10 and a further cross section q2 at the end of the control chamber 2 which faces the outlet 12. In the example embodiment that is shown, cross section q1 is smaller than cross section q2. In a different example embodiment, however, the end of the control chamber 2 that faces the intake 10 can be provided with the larger cross section and the end of the control chamber 2 that faces the outlet 12 can be provided with the smaller cross section. In the example embodiment that is shown, however, q1 is smaller than q2.

In the example embodiment that is shown, the control chamber 2 has a conical design, which is shown in the sectional view in FIG. 1 by the trapezoidal cross section. The cross section in this case is to be understood as rotationally symmetric about the axis 100 of the device 1.

However, any other shape of the cross section of the control chamber 2, or the contour of the cross section, in each case perpendicular to the axis 100 of the device 1, is also conceivable provided that between the end of the control chamber 2 that faces the intake 10 and the end of the control chamber 2 that faces the outlet 12 the cross section varies, and is larger in at least one position than in another position. The cross sections can also be designed not to be rotationally symmetric about the axis 100 of the device 1.

The contour of the cross section of the control chamber 2 between the end of the control chamber 2 facing the intake 10 and the end of the control chamber 2 facing the outlet 12 can also follow another pattern. For example, the middle region of the control chamber 2 can be constricted or bulging in comparison with the outer regions.

In the example embodiment that is shown, between the end of the control chamber 2 that faces the intake 10 and the end that faces the outlet 12, the interior walls 20 of the control chamber 2 extend linearly. As a result, between the end facing the intake 10 and the end facing the outlet 12, there is a stepless variation, which follows a predetermined mathematical function, in the cross section of the control chamber 2. The radius of the control chamber 2 thereby changes linearly, and thus the cross section of the control chamber with a given radius r can be calculated by A=π*r². Accordingly, a quadratic relationship exists between the radius r, which changes linearly, and the cross section of the control chamber.

The stepless configuration of the cross sections of the control chamber 2 enables a stepless variation in the effective cross section, and hence also a stepless variation in the flow rate of the fill product through the device 1.

In the example embodiment that is shown, the control element 3 is implemented in the form of a ball, and is here implemented as a magnetic steel ball. The surface of the control element 3 is smooth, with the result that the control element 3 is easy to clean. The interior walls 20 of the control chamber 2 are also smooth, so that here too cleaning can be carried out easily using conventional methods, and a hygienic design can accordingly be provided.

In other embodiments, the control element 3 can have not only a ball shape, but also the shape of a spheroid, a prism, a teardrop, an egg or another shaped body.

The control element 3 is accommodated fully within the control chamber 2, and can therefore be fully immersed in or at least wetted by the fill product flow. In other words, the control element 3 has no mechanical connection extending outside the control chamber 2, and thus, there is no portion of the control element 3 that lies in a “dry” region of the device 1.

The drive 4 acts on the control element 3 by means of a magnetic element 40, which interacts magnetically with the control element 3 through the applicable wall of the control chamber 2. When the magnetic element 40 of the drive 4 is displaced along the wall of the control chamber 2, the control element 3 is caused to move along with it, and can in this manner be displaced and positioned within the control chamber 2.

In other words, the connection between the drive 4 and the control element 3 is implemented in a contact-free manner, and the interaction, e.g., the transmission of the adjusting forces applied by the drive 4 to the control element 3, takes place without direct mechanical contact.

The magnetic element 40 is guided on the drive 4 by means of a spindle nut 42 on a spindle 44 driven by a motor 46, which is, in some embodiments, implemented as a stepper motor. The use of the stepper motor makes it possible to achieve defined and reproducible displacement of the drive 4 to a predetermined position, with the result that a predetermined position of the control element 3 in the control chamber 2 can also be reproducibly reached.

Accordingly, a quasi-stepless displacement and positioning of the magnetic element 40 can be achieved, so that the control element 3, which is magnetically coupled with the magnetic element 40, can correspondingly be displaced and positioned steplessly in the control chamber 2. Operation of the motor 46 thus leads to rotation of the spindle 44, which in turn leads to a displacement of the spindle nut 42 and thereby also of the magnetic element 40, such that the control element 3 can be displaced and positioned within the control chamber 2 analogously to the magnetic element 40.

The accommodation of the control element 3 in the control chamber 2 thereby reduces the cross section q3, which is effectively available for the flow, and which is formed between the circumference of the control element 3 and the corresponding regions of the opposite side of the interior wall 20 of the control chamber 2. When the control element 3 is displaced and positioned within the control chamber 2, which has a varying cross section, the cross section that is effectively available for the flow can also be varied in this manner.

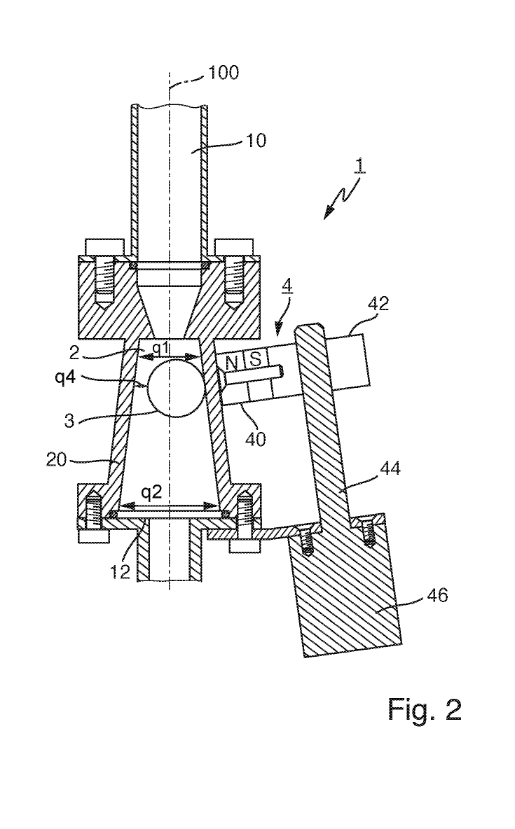

In this context, FIG. 1 shows a first position of the control element 3 within the control chamber 2, in which a first effective flow cross section q3 is provided. FIG. 2 shows the device 1 in a second position, in which the drive 4 has brought the control element 3 to a position closer to the intake 10, where the cross section q1 of the control chamber 2 is smaller, so that here, between the control element 3 and the nearest corresponding interior walls 20 of the control chamber 2, there is an effective flow cross section q4 which is smaller than the flow cross section q3 shown in FIG. 1. It can immediately be recognized that, due to the conical design of the control chamber 2, e.g., of the interior walls 20 of the control chamber 2, the effective flow cross section can be varied steplessly by means of the stepless displacement of the control element 3 from the end of the control chamber 2 that faces the intake 10 to the end of the control chamber 2 that faces the fill product outlet 12.

The control element 3 is thus displaced and positioned by means of the drive 4 between an end position with a small effective flow cross section q4, as shown in FIG. 2, and a position with a large effective flow cross section q3, as shown in FIG. 1. In this, the movement of the drive 4 is confined between the end position with the small effective flow cross section and the end position with the large effective flow cross section. Accordingly, the control element 3 cannot be displaced to a position in which it closes the device 1 completely. By this means it is achieved that the control element 3 is completely surrounded by the fill product at all times, and consequently the pressure conditions exerted by the fill product from all sides upon the control element 3 are substantially identical at all times (the only exception being due to possible variation in the height of the fluid column).

In this manner, it can be achieved that the forces that need to be exerted by the drive 4 on the control element 3, in particular the forces that need to be exerted by the magnetic element 40 on the control element 3, are independent of the pressure conditions in the control chamber 2. It is therefore possible to limit the dimensions of the magnetic element 40 of the drive 4 and the choice of material for the control element 3 according to these forces. It is thus not necessary to design the drive 4, and in particular the magnetic element 40, to be strong enough also to lift the control element 3 out of a position in which it has closed the control chamber 2. If, for example, the control element 3 were to block the outlet 12, the side that faced the control chamber 2 would be subjected to a higher pressure, and hence greater forces in the direction of the closure. These forces would have their origin in the fluid column of fill product bearing upon the control element 3 as it blocked the outlet 12. On the side facing the outlet 12, only for example, atmospheric pressure would be obtained during closure. Thus, in this case a large force would need to be applied to lift the control element 3 back out of the closed position. This need is obviated by the confinement of the drive 4 to movement between the two end positions, which continue to provide a minimum flow, and hence the dimensions of the control element 3 and the magnetic element 40 of the drive 4 can be moderate while still adequate with regard to their interaction.

The result is thus a low-wear and low-maintenance device 1 for varying the flow rate of a fill product, which at the same time can provide a good hygienic design.

To the extent applicable, all features described in the individual example embodiments can be combined with each other and/or exchanged, without departing from the field of the invention.

1. A device for varying the flow rate of a fill product in a filling plant, the device comprising:
a control chamber connected with and disposed between an intake and an outlet;
a control element housed within the control chamber; and
a drive disposed outside the control chamber,
wherein the control element is configured to be displacable within the control chamber by interaction with the drive, and
the control chamber has a cross section that varies steplessly between an end of the control chamber facing the intake and an end of the control chamber facing the outlet.

2. The device of claim 1, wherein the cross section of the control chamber varies linearly from the end facing the intake to the end facing the outlet.

3. The device of claim 1, wherein the cross section of the control chamber varies continuously between the end facing the intake and the end facing the outlet.

4. The device of claim 1, wherein the control chamber is conical in shape.

5. The device of claim 1, wherein the control element is configured to be displaceable by the drive between a position with a first cross section and a position with a second cross section, the second cross section being larger than the first cross section.

6. The device of claim 5, wherein the control element is configured to be linearly displaceable by the drive between the position with the first cross section and the position with the second cross section.

7. The device of claim 5, wherein the drive is confined between a first end position in which the control element provides the first cross section and a second end position in which the control element provides the second cross section.

8. The device of claim 7, wherein the drive comprises a stop to confine the movement of the drive between the first end position and the second end position.

9. The device of claim 8, wherein the stop is implemented in the drive mechanically.

10. The device of claim 1, wherein the control element is spherical in shape.

11. The device of claim 1, wherein the drive and control element interact with each other without direct mechanical contact.

12. The device of claim 1, wherein the control element is housed entirely within the control chamber.

13. The device of claim 1, wherein the control element is magnetically coupled to the drive.

14. The device of claim 1, further comprising one or more bars, ribs, deflectors, deflecting brackets, spacers, and stops disposed in an area of the outlet to prevent complete closure of the control chamber.

15. A device for varying the flow rate of a fill product in a filling plant, comprising:
a control chamber connected with and disposed between an intake and an outlet;
a spherical control element housed within the control chamber; and
a drive disposed outside the control chamber,
wherein the control element is magnetically coupled to the drive and configured to be displacable within the control chamber by interaction with the drive, and the control chamber has a cross section that varies steplessly between an end of the control chamber facing the intake and an end of the control chamber facing the outlet.

16. The device of claim 15, wherein the cross section of the control chamber varies linearly from the end facing the intake to the end facing the outlet.

17. The device of claim 15, wherein the control chamber is conical in shape.

18. The device of claim 15, wherein the control element is configured to be displaceable by the drive between a position with a first cross section and a position with a second cross section, the second cross section being larger than the first cross section.

19. The device of claim 15, wherein the drive and control element interact with each other without direct mechanical contact.

20. The device of claim 15, further comprising one or more bars, ribs, deflectors, deflecting brackets, spacers, and stops disposed in an area of the outlet to prevent complete closure of the control chamber.
